(19) United States
(12) Patent Application Publication
(10) Pub. No.: US 2026/0359757 A1
(43) Pub. Date: Nov. 12, 2026

(54) SYSTEM AND METHOD FOR BRAND ADHERENT CONTENT GENERATION USING AN AUTOMATED ARTIFICIAL INTELLIGENCE POWERED AND AGENT CENTRIC FRAMEWORK

(71) Applicant: Salesforce, Inc., San Francisco, CA (US)

(72) Inventors: Nikhil KAPRE, Bangalore (IN); Jayakrishnan Radhakrishna PILLAI, Bangalore (IN); Krishna SUVARNA, Hyderabad (IN); Tarundeep BATRA, San Francisco, CA (US)

(73) Assignee: Salesforce, Inc., San Francisco, CA (US)

(21) Appl. No.: 19/204,189

(22) Filed: May 9, 2025

(51) Int. Cl. G06Q 10/0633; G06F 21/10; G11B 27/031

(52) U.S. Cl. CPC G06Q 10/0633; G06F 21/106; G11B 27/031

(57) ABSTRACT

Disclosed herein are system, method, and computer program product aspects for generating brand adherent content using an automated artificial intelligence (AI) powered and agent centric framework. An example embodiment queries an artificial intelligence (AI) agent, using a prompt to generate a plurality of components associated with content specified by a user device for an output channel. The embodiment queries the AI agent, using the prompt and a brand configuration associated with the content, to refine the plurality of components. The embodiment stitches the refined plurality of components to generate a video. The embodiment updates, based on an approval workflow set up in the enterprise, the video to incorporate a change determined from the approval workflow. The embodiment then incorporates the video into a template associated with the brand configuration for the output channel to generate an output version of the video.

### BACKGROUND

Generating professional content at scale is inherently challenging. Human error, an iterative nature of content creation, and a need to adhere to diverse and ever-changing brand guidelines, target audiences, and media formats all contribute to this difficulty. Enterprises need the ability to generate content for emails, newsletters, social media updates, and other platforms in different formats (e.g., text, image, video, sound, etc.) in which the content needs to adhere to branding guidelines of the enterprise.

### BRIEF DESCRIPTION OF THE FIGURES

The accompanying drawings are incorporated herein and form a part of the specification.

FIG. 1 is a block diagram illustrating a content generation system, according to aspects of the present disclosure.

FIG. 2 is a block diagram illustrating a generation agent platform of a content generation engine, according to aspects of the present disclosure.

FIG. 3 is a block diagram illustrating a generation agent actions setup component of a content generation engine, according to aspects of the present disclosure.

FIG. 4 is a block diagram illustrating a content configurator of a content generation engine, according to aspects of the present disclosure.

FIG. 5 is a block diagram illustrating a cloud service and database of a content generation engine, according to aspects of the present disclosure.

FIG. 6 is a block diagram illustrating an operational framework of a content generation system, according to aspects of the present disclosure.

FIG. 7 is a flowchart illustrating a method for brand adherent content generation, according to aspects of the present disclosure.

FIG. 8 illustrates an example computer system useful for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method and/or computer program product embodiments, and/or combinations and sub-combinations thereof, for brand adherent content generation using an automated artificial intelligence (AI) powered and agent centric framework.

Generating professional content that aligns with branding guidelines can be challenging because it requires a balance between creativity, accuracy to the brand voice, adherence to specific visual and messaging parameters, ensuring internal alignment across teams, and staying updated with evolving brand guidelines. Conventional content generation system suffers from technological challenges, including but not limited to, a lack of maintaining consistency across channels (e.g., of the enterprise), an inaccuracy in interpreting branding guidelines, unbalancing creativity with brand integrity, a lack of adaption to different audiences, and/or inability of keeping content generation relevant and timely as brand guidelines evolve.

The embodiments disclosed herein provide a content generation system to automatically generate brand-adhered content in a consistent manner. The content generation system is an AI-powered and agent centric system or framework that addresses the above technological challenges. By considering relevant attributes, market segmentation, and brand guidelines, the content generation system can continuously evolve and leverage existing infrastructure and application programming interface (APIs) to generate dynamic and conversational content. The content generation system streamlines content generation through multiple processes, including but not limited to, configuration setup, user requirement capture, content generation, brand tuning, content approval, infringement checks, and/or output channel transformation.

Configuration setup refers to a process of setting up or specifying settings, options, or parameters that the content generation system needs to operate correctly. This includes defining how the content generation system behaves, what resources it uses, and how it interacts with its environment, ensuring that generated content aligns with specific brand guidelines. The configuration setup may include, but is not limited to, a brand guidelines ingestion, a styles ingestion, and/or a template ingestion.

In some aspects, for addressing inaccuracy in interpreting branding guidelines, the content generation system, during configuration setup, may leverage an AI system or a natural language processing (NLP) model to understand and interpret the guidelines'core elements (e.g., visual elements, tone of voice, messaging, etc.). These AI systems or NLP models can pay attention to specific visual elements in the guidelines, including but not limited to, color palettes, typography, imagery style, and/or logo usage guidelines. The content generation system may also ingest brand's styles in contention generation in which the system can at least familiarize, generalize, and/or memorize the brand's voice and style, whether it is formal, informal, humorous, or serious. In addition, the content generation system may ingest any templates and apply them consistently across all content formats (e.g., social media posts, blog articles, email newsletters), ensuring that the content reflects the brand's values and identify. In some aspects, for addressing inability of keeping content generation relevant and timely as brand guidelines evolve, the content generation system, during configuration setup, may utilize any tools or systems to regularly review and monitor any changes having been made to the brand guidelines (e.g., before generating the content). The tools may provide a real-time insights or summary of the brand guidelines. The tools may also analyze the data collected regarding the changes of the brand guidelines to identify trends and potential issues. Based on the analysis, the tools may take further steps to improve performance, address issues, and ensure the generated content compliant with the brand guidelines.

User requirement capture is the process of understanding and documenting what user devices need from a system or service to achieve their goals, ensuring the final content generation for an output channel and in a specified format or combination of formats effectively meets their needs and expectation. The user requirement capture may support functionalities, including but not limited to, capturing user's requirement in natural language, dynamic creation of prompt instructions to be used along with system prompts, and/or ingesting website content that needs correction per branding guidelines.

In some aspects, for addressing a lack of adaption to different audiences or user devices, the content generation system, during user requirement capture, may have a user-centric design that ensures the design the development process is focused on the needs of different audiences or user devices. The content generation system can capture and analyze user's requirement in natural language using an AI, NLP, or agentic systems or models. These systems or models can transcribe the natural language input from the user device in a real-time manner into a prompt instruction that can be further used to adjust the content based on the user requirement. This natural language transcription may also support a real-time translation of the transcripts between different languages. In some aspects, for different audiences or user devices, the content generation system can ingest website content that needs correction per branding guidelines based on any user requirement (can be from different user devices at different time). The content generation system may first identify the content needing attention, then compare it against the brand guidelines, and finally implement the necessary changes that are consistent in messaging, visuals, and tone. For example, when the user device inputs a user desire that a part of the content deviates from the brand guidelines, the content generation system may leverage the AI, NLP, or agentic systems to look for deviation instances in the content based on the user input. The system may then prioritize the inconsistencies and edit the content to align with visuals, messaging, layout and structure as indicated by the brand guidelines.

Content generation is the process of creating digital media like text, images, videos, and audio to be deployed on the internet or other channels, aiming to engage audiences through compelling and relevant content. During the content generation, the content generation system can generate content for a user specified topic with any instructions. The generated content can also cover multiple output formats or modalities, including but not limited to, text, image, video and/or audio.

In some aspects, unlike conventional systems, the content generation system can leverage AI-powered and agent centric system to generate outputs that incorporate the multiple modalities. This can be done by training or fine-tuning the AI or agentic systems using data that includes multiple modalities, allowing the systems or models to generate output that is informed by more than one type of data. In some aspects, the AI or agentic systems can be trained or fine-tuned to generate captions for images that incorporate both text and visual information. The AI or agentic systems can also learn to identify objects in the image and generate descriptions of them in natural language, while also taking into account contextual information and the relationships between the objects in the image. In addition, the AI or agentic systems can also generate realistic images from textual descriptions or generating audio descriptions of video content. In some aspects, the AI or agentic systems may also be queried in a zero-shot manner which leverage pre-existing knowledge and capabilities of the systems to create content from multiple modalities without requiring specific training data for the task.

Brand tuning of the content generation is a process to refine the created content to align with a specific brand guidelines. During the brand tuning, the content generation system can define how the content generation system behaves, what resources (e.g., brand guidelines) it uses, and how it interacts with its environment, ensuring that generated content aligns with specific brand guidelines.

In some aspects, unlike conventional systems, the content generation system can generate content that adheres to brand guidelines using retrieval-augmented generation (RAG) that integrate the brand guidelines as part of the knowledge base. The RAG can ensure the system performance by grounding responses in those brand guidelines. For example, when being queried, the AI or agentic systems can ground the responses using the brand guidelines to generate content that reflects the brand identity. In some aspects, the content generation system can also fine-tune or train the AI or agentic systems using the knowledge base with the integrated brand guidelines.

Unlike the conventional systems, the content generation system can trigger an automated approval flow. This automated approval flow may streamline or replace the manual approval flow performed in the conventional systems that multiple functional groups or departments may be involved in the decision making about an external facing content. By using this automated approval flow, the approvals for generated content can be triggered via a pre-configured approval chain. This approval chain can also be subject to certain rules that can be triggered to ensure that the approval of all required individuals or procedures are sought.

Furthermore, unlike the conventional systems, the content generation system may perform infringement checks based on the AI or NLP systems to prevent plagiarism in assignments and tests. These AI or NLP systems may analyze the context and semantics of the text to identify paraphrased content and more sophisticated forms of plagiarism that cannot be detected by conventional systems. In some aspects, the content generation system may, as at least part of the plagiarism detection, compare the text of the submitted document against a database of existing documents, including academic papers, websites, and other student submissions. When comparing two texts, string matching algorithms including the Rabin-Karp algorithm, Knuth-Morris-Pratt (KMP) algorithm, and/or others that would be appreciated by a person with ordinary skills in the art can be used to find matching substrings within the text. Exact matches or near matches of phrases and sentences can be found during this comparison. In some aspects, the content generation system may create a unique fingerprint or hash of a document based on its content. The fingerprint may then be compared against a database of fingerprints from other documents to find any similarities. In some aspects, the content generation system can analyze the citations and references in a document to ensure they are properly formatted and attributed. This helps in identifying cases where sources are not properly cited. In some aspects, the content generation system may also analyze the writing style of the document, including factors like word choice, sentence structure, and/or punctuation, to identify if a document has been written by multiple authors or if it deviates significantly from a user's usual writing style. In some aspects, the content generation system may be capable of detecting plagiarism across different languages by translating the text and then performing similarity checks.

In addition, once content is generated in the appropriate format, it needs to be set in a layout that is best suited for the output channels. Unlike the conventional systems, this transformation only applies to the generated text output which has an image, video, and audio links into it. For the enterprise and desired output channel, the appropriate template can be retrieved from the configuration and populated with the necessary text. For the image, video, and audio content, appropriate links may be inserted along with the necessary thumbnails.

In summary, this disclosure is directed to a content generation system for automatically generating brand-adhered content in a consistent and concise manner. With the help of the content generation system, massive human effort can be reduced for webpage product description generation, especially for big catalogs. Generated descriptions quality can be increased in which the generated content can empower shoppers to take the right purchase decision. The generated content can also adhere to branding guidelines and can be appropriate for targeted users. Furthermore, the content generation system can reduce time and efforts to be taken in organization review and approval cycles, making periodic generation and update of product descriptions more easily possible. These and other aspects of the present disclosure will be described in further detail below with respect to the accompanying drawings.

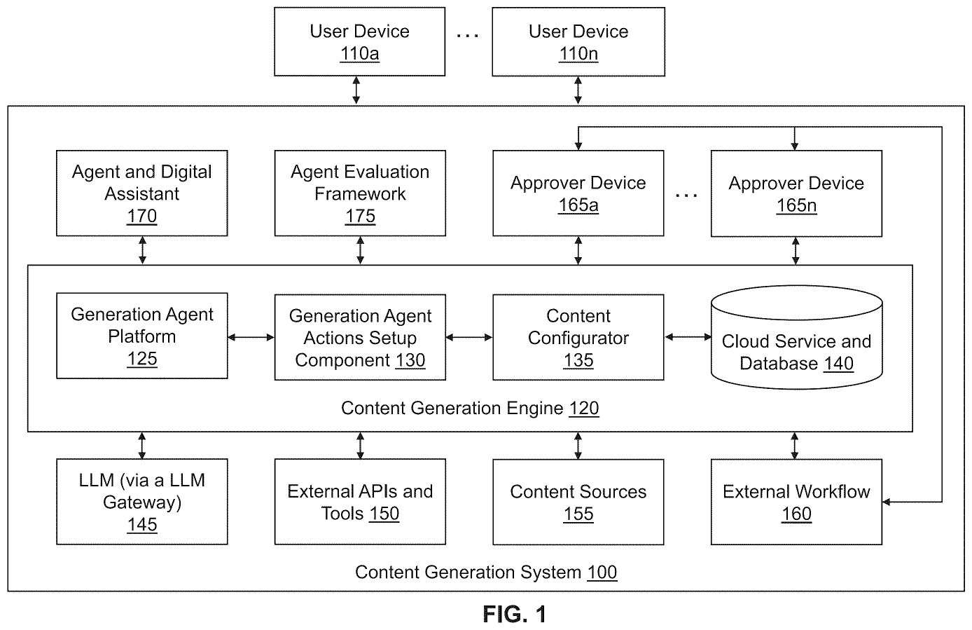

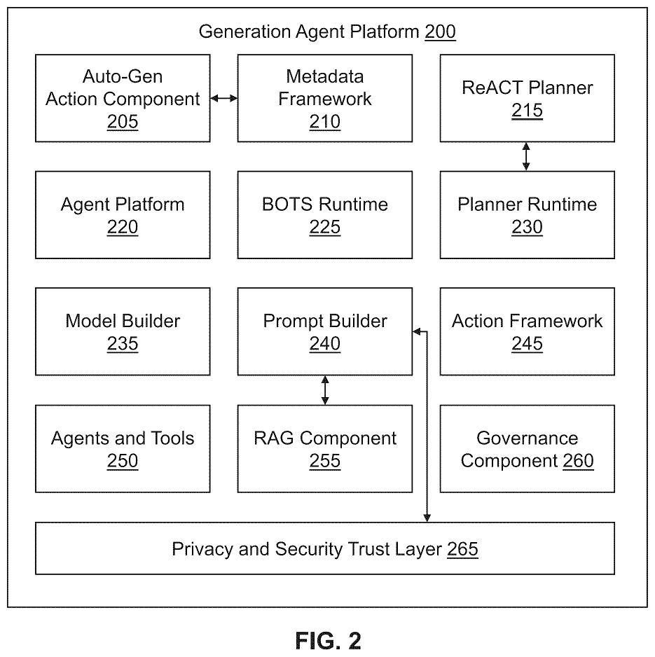

FIG. 1 is a block diagram illustrating a content generation system 100, according to aspects of the present disclosure. In some aspects, content generation system 100 may include, but is not limited to, an agent and digital assistant 170, an agent evaluation framework 175, a content generation engine 120, an LLM 145, APIs and tools 150, content sources 155, an approval workflow 160, and/or approver devices 165a-n. Content generation engine 120 may further include, but is not limited to, a generation agent platform 125, a generation agent actions setup component 130, a content configurator 135, and a cloud service and database 140. The detailed components of the content generation engine will be further explained in at least FIGS. 2-5.

Content generation engine 120 may be configured to interface with agent and digital assistant 170 (e.g., a browser for user devices 110a-n) to open a remote takeover session on the endpoint or execute tasks on it, and it may allow the content generation engine to connect to more than one user devices at the same time. In some aspects, user devices 110a-n may be a separate computing platform including but not limited to smartphones, tablet computers, laptop computers, desktop computers, web browsers, and/or other computing devices, apparatuses, systems, or platforms. In some aspects, user devices 110a-n may transmit information to content generation system 100 either in a wired or wireless manner and may be, for example, the Internet, a Local Area Network, or a Wide Area Network. The transmission may utilize a network protocol, such as, for example, a hypertext transfer protocol (HTTP), a transmission control protocol (TCP)/Internet protocol (IP) protocol, Ethernet, or an asynchronous transfer mode.

Content generation engine 120 may be configured to interface with agent evaluation framework 175 to score brand specific content. In some aspects, the agent evaluation framework may include a structured approach to assess and understand the performance of the agents (e.g., AI agents), focusing on their ability to execute tasks, make decisions, and interact with user devices. The agent evaluation framework may also help developers evaluate the quality, cost, latency of agentic AI applications, including RAG applications and chains, and determine their root causes. In some aspects, agent evaluation framework 175 may often use an LLM agent (e.g., evaluator) to orchestrate conversations with the target agent and evaluate its responses, offering a scalable and cost-effective alternative to traditional human evaluations. In some aspects, some agent evaluation frameworks may also allow for defining custom metrics in natural language to assess an agent's workflow.

Content generation engine 120 may be configured to interface with various content sources 155, including but not limited to, external websites, and/or internal or external branding guidelines (e.g., or files) of the enterprise in any formats, from which information is accessed and used. Content generation engine 120 may be configured to interface with APIs and tools 150 (e.g., can be internal or external provided by a third-party service) to integrate applications of the content generation engine with any internal or external systems or platforms. These APIs or tools may expose functionalities and data to external user devices, expanding application capabilities and facilitating any application or API development, testing, monitoring, and management purposes.

Content generation engine 120 may also be configured to interface with an LLM 145 via an LLM gateway for implementing applications for a range of NLP task including text or content generation. In some aspects, an LLM gateway is a centralized orchestration platform that improves the deployment and management of one or more LLMs in production environments. It abstracts the complexities of working directly with individual models, offering a unified interface to connect applications with the one or more LLMs (e.g., an LLM 145).

In addition, content generation engine 120 may be configured to interface with an approval workflow 160 to approve the content being generated. In some aspects, within the approval workflow, the content generation engine may be configured to interface with one or more approver device 165a-n in which these devices may be configured to consolidate any changes or suggestions to the generated content and ensure these changes or suggestions are incorporated into the content. In some aspects, approver devices 165a-n may transmit information to content generation engine 120 either in a wired or wireless manner and may be, for example, the Internet, a Local Area Network, or a Wide Area Network. The transmission may utilize a network protocol, such as, for example, a hypertext transfer protocol (HTTP), a transmission control protocol (TCP)/Internet protocol (IP) protocol, Ethernet, or an asynchronous transfer mode.

FIG. 2 is a block diagram illustrating a generation agent platform 200 of a content generation engine 120, according to aspects of the present disclosure. In some aspects, generation agent platform 200 may include, but is not limited to, auto-generation action component 205, a metadata framework 210, a ReACT planner 215, planner runtime 230, BOTS runtime 225, an agent platform 220, a model builder 235, a prompt builder 240, an action framework 245, agents and tools 250, a RAG component 255, a governance component 260, and/or a privacy and security trust layer 265.

Auto-generation action component 205 may be configured to interface with metadata framework 210 to create custom actions with a streamlined user interface and functionality. The auto-generation action component may automatically generate quick actions or global actions for specific record types or across generation agent platform 200. In some aspects, the quick actions are actions that are specific to a particular object or record type, which appear in the record page's action menu. For example, if a user device realizes that a funding request needs to be created when a new contact is added, the user device can add an action to the contact record that allows other user devices to do exactly that without extra navigation. The global actions are actions that are available across the generation agent platform, appearing in the global publisher layout. Actions are often accompanied by metadata associated with the metadata framework that provides context and information about the action in which the metadata may include, but is not limited to, action type, action input, action output, agent role, and/or conversation context. The action type may indicate the type of action being performed (e.g., code execution, tool usage). The action input may specify the input required for the action. The action output may store the result of the action. The agent role may identify the agent performing the action. The conversation context may provide information about the current conversation.

ReACT planner 215 may be configured to interface with planner runtime 230 to schedule and plan actions. For example, ReACT planner 215 may be designed for scheduling and planning actions and applications. ReACT planner 215 may facilitate the creation of user interfaces for managing schedules, tasks, and events in which the ReACT planner may support features such as drag-and-drop functionality, customizable catalogs, and two-dimensional or three-dimensional visualization. Planner runtime 230 may refer to the environment in which a react planner application executes in which the ReACT planner may rely on the planner runtime to function correctly. The planner runtime may provide the necessary tools and resources for the components to render and interact with the user device. In some aspects, the core engine of planner runtime environment may be JavaScript in which the JavaScript core may enable the execution of code and manage the application's state and behavior.

BOTS runtime 225 may refer to an environment or infrastructure in which generation agent platform 200 may execute any chat bot applications (e.g., or some other AI applications or solutions). The BOTS runtime may support an automated interaction with the user devices and enable the chat bot applications to at least understand inputs (e.g., equations or requests) from the user devices, access and process data (e.g., user records, knowledge base, etc.) from the generation agent platform, generate appropriate responses or take actions, and/or handle complex interactions and scenarios. In some aspects, the BOTS runtime may support a conversational flow or scripts to define how the chat bots may interact with the user devices and provide tools for integrating the chat bots into various communication channels such as web chat, mobile apps, etc.

Agent platform 220 may refer to tools for building and deploying autonomous AI agents that can handle specific tasks and processes to augment human workers across various business functions. In some aspects, the agent platform deploy various AI agents, including but not limited to, a service agent, a sales agent, a marking agent, a commerce agent, and/or a platform agent. The service agent may deflect incoming support cases by responding to customer inquiries. The sales agent may proactively contact customers, respond to their questions, and schedule meetings that may create any potential business. The marketing agent may generate briefs, audience segments, content, and customer journeys. The commerce agent may offer AI-powered shopping assistance on commerce sites or messaging apps. The platform agent may assist with various tasks across different departments. In some aspects, these AI agents may be built on the agent platform, based on existing agents or tools 250. These AI agents can connect to any data source and use it in real-time to plan, reason, and evaluate. These AI agents can also leverage any workflow, automation, or API to complete tasks. These AI agents can operate autonomously (e.g., within a defined guideline to ensure accuracy and consistency), retrieving data on demand, building action plans, and executing them without human intervention. In some aspects, when building these AI agents, agent platform 220 may enable admin or developer devices to use natural language to create instructions and guidelines for their agents. The agent platform may connect to at least enterprise data and security models to automate the operations. The agent platform may also use generative AI and LLM to synthetize natural and human-like conversations.

Model builder 235 may refer to tools that allows user devices to build and integrate custom models, including but not limited to, an LLM, NLP models, and/or other AI models into generation agent platform 200. Prompt Builder 240 may refer to tools that allows user devices to create, test, and manage prompt templates for the generation agent platform to generate content (e.g., summaries, descriptions, or emails) or execute other generative AI tasks. Prompt Builder 240 may use the privacy and security trust layer 265 to mask sensitive data, ensuring data security and accuracy. In some aspects, prompt builder 240 may be configured to interface with a RAG component 255 to generate customized prompt to querying the LLM or other AI models. The RAG component may include a retriever that finds relevant information from an external knowledge base and be coupled with a generator (e.g., typically a LLM or any other AI models) that uses the retrieved information to produce a response. In some aspect, the retriever may include an AI model or algorithm that searches the knowledge base for relevant information based on a query from the user device. The knowledge base may include documents, database, and/or other data repositories. The knowledge base may often be indexed or vectorized to enable efficient and semantic search. The retrieved information may be incorporated into the prompt (e.g., created by the prompt builder) provided to the generator to guide the generation process. The retrieved information may augment the generator's internal knowledge, leading to more factual and contextually relevant responses.

Action framework 245 may be a metadata-driven framework that allows user devices to dynamically instantiate trigger actions for an object when records are inserted, updated, deleted, or undeleted in generation agent platform 200. The action framework may enable better organization and control of trigger logic. In some aspects, the action framework may use custom metadata to configure trigger logic in which the action framework may support the user devices to partition the trigger logic into small, reusable classes for each action. This logic partition may promote code organization and maintainability and allow for easier logic management and deployment. The action framework may allow user devices to define the order in which the actions can be executed within a given context. The action framework may also support a bypass mechanism in which the user devices or developers can define a mechanism to bypass specific actions under certain conditions, providing flexibility in handling complex action scenarios. In addition, the action framework may support the user devices to choose the appropriate tool for each action.

Governance component 260 may refer to a structured framework and processes used to organize and oversee the use and development of the environment of generation agent platform 200 within an organization, ensuring a compliance with business goals and regulatory requirements, efficiency, scalability, data integrity and security.

Privacy and security trust layer 265 may refer to a robust set of features and guardrails that protect the privacy and security of the data, improve the safety and accuracy of the AI results, and promote the responsible use of AI across the generation agent platform 200. In some aspects, the privacy and security trust layer may support features, including but not limited to, dynamic grounding, zero data retention, and/or toxicity detection, to help the user devices unleash the power of generative AI without compromising the safety or security standards.

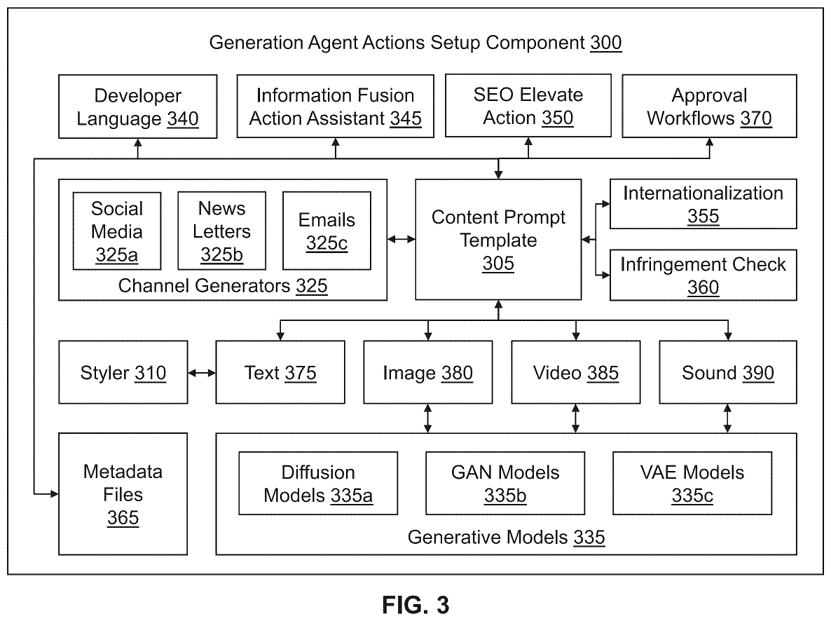

FIG. 3 is a block diagram illustrating a generation agent action setup component 300 of a content generation engine 120, according to aspects of the present disclosure. In some aspects, generation agent action setup component 300 may include, but is not limited to, a developer language 340, an information fusion action assistant 345, a SEO elevate action 350, an approval workflow 370, a channel generator 325, a content prompt template 305, an internationalization 355, an infringement check 360, a metadata file 365, and/or a generative model 335. Generation agent action setup component 300 may also support different output formats, including but not limited to, text 375 (e.g., with a coupled styler 310), image 380, video 385, and/or sound 390.

Developer language 340 may include, but is not limited to, a programming, scripting, and/or any other developer languages that would be appreciated by a person with an ordinary skill in the art. The developer language may allow developers or user devices to execute flow and transaction control statements in generation agent action setup component 300 in conjunction with calls to the API. In some aspects, the developer language may enable developers to add business logic to most system or platform events, including but not limited to, button clicks and/or related record updates.

Information fusion action assistant 345 may be configured to perform actions based on recommendations, such as creating tasks or events, or editing records, related to data fusion or integration scenarios. The information fusion may refer to combine data different sources to create a more comprehensive view of information. In some aspects, information fusion action assistant 345 may offer action recommendations related to the data fusion to the user devices such that the user devices can create the task or event directly from the recommendations.

SEO elevate action 350 may refer to a process of optimizing website for search engines, ensuring that content is discoverable and ranks well. In some aspects, the SEO elevate action may include, but is not limited to, on-page optimization, page or site architecture improvement, and/or linking building. For example, relevant keywords that the target audience uses to find product or service may be identified as keywords. The product descriptions, page titles, and meta-descriptions may then be optimized based on these keywords. Images with descriptive alt text and filenames may also be optimized. Structured data (e.g., schema markup) may be implemented to help search engines understand the content of the page. A sitemap may also be created and submitted to the search engines to help them crawl the page. In addition, internal linking to relevant pages with the website or external linking to other websites may be created to boost the search engine efficiency and effectiveness.

Channel generator 325 may integrate multiple channels into the generation agent action setup, including but not limited to, a social media 325a, a new letter 325b, and/or an email 325c, to effectively lead content generation and customer engagement across these various channels. Such integration of multiple channels may gain a comprehensive view of customer interactions across all channels. In some aspects, channel generator 325 may adaptively weigh (e.g., reply in a faster manner) different channels based on different marketing or business strategies. For example, the channel generator may respond to inquiries and feedback on a social media quicker than those in an email, improving customer satisfaction and loyalty. The channel generator may also leverage social media channel and data to refine marketing strategies and campaigns. In some aspects, the channel generator may collaborate with content prompt template 305 to customize the prompt for querying the LLM to generate specialized content within a particular channel (e.g., a personalized sales email within an email channel 325c).

Content prompt template 305 may refer to a pre-defined structure or format used to generate prompts for querying an LLM or other AI models. The content prompt template may contain placeholders for dynamic and static content, instructions, and context, allowing for efficient and consistent prompt creation. For example, the content prompt template for generating product descriptions might include placeholders for product name, features, and benefits. The content prompt template for replying customer support inquiries may include placeholders for the customer's issue, product, and any actions to be taken. The content prompt template for writing blog posts may include placeholders for the topic, target audience, and keywords.

In some aspects, content prompt template 305 may be interfaced with internationalization 355 and infringement check 360. The internationalization may adapt content prompt template 305 to at least different languages, cultures, regions, and locale-specific data, preparing it for an easier and more efficient localization. The infringement check may access security setting of content prompt template 305 to identify any potential risks including those related to data breaches, security vulnerabilities, or compliance issues. For example, the infringement check may help to prevent unauthorized access to sensitive data, such as customer information, financial data, or intellectual property. The infringement check may also identify potential weaknesses in content configurations, user permissions, or code that could be exploited by malicious actors. In addition, the infringement check may ensure that usage of the content prompt template complies with any relevant regulations and industry standards.

In some aspects, content prompt template 305 may be configured to different output formats, including but not limited to, text 375, image 380, video 385, and sound 390. The content prompt template may provide a standardized approach to constructing prompts, allowing user devices to maintain a consistent format while easily adapting the content for different use cases. They act as a blueprint for creating prompts that effectively guide the LLM or AI models to produce content with a desired output format. In some aspects, the content prompt template may start with a sentence or phrase that clearly states the purpose of the prompt, for example, “Generate an image of . . . ,” “Create a visual representation of . . . ” or “Write a short story about . . . ” The content prompt template may also incorporate any descriptive details, including but not limited to, subjects, setting, action, activity objects, mood, and/or atmosphere. For example, the subjects may be specific about what the image or text should depict. The setting may include details about the location or environment. The action or activity may describe what is happening in the image or story. The object may mention any specific objects or items that should be included. The mood or atmosphere may additionally indicate the desired feeling or tone.

In some aspects, text 375 may be configured to interface with a styler 310. The styler may specify linguistic and stylistic choices that characterize a piece of written content, such as tone, vocabulary, sentence structure, and formatting, which can be modeled and manipulated to achieve specific communicative goals. In some aspects, image 380 may also be configured to interface with a styler 310. The styler may specify an image generation style (e.g., photorealistic, abstract, impressionistic, watercolor, etc.). The styler may mention any specific colors or color schemes and describe the lighting conditions (e.g., bright, dim, dramatic, natural light). The styler may also specify the desired viewpoint of camera angle or perspective: (e.g., wide shot, close-up, high angle). In addition, the styler can specify the image format, including but not limited to, a photo, illustration, or other formats.

Metadata files 365 may refer to the configuration and customization information that defines the structure and behavior of generation agent actions setup component 300, including settings, configurations, and declarative customizations. The metadata files may encompass the configurations, layouts, and settings that define how the platform behaves, such as object relationships, field layouts, and automation rules. For example, the metadata files may include, but are not limited to, custom objects, fields, page layouts, workflows, validation rules, reports, dashboards, and/or user permissions. In some aspects, an internal or external tools or systems may be used to manage the metadata files, enabling the deployment, retrieval, creation, update, or deletion of customization information, such as custom object definitions and page layouts. In some aspects, the metadata files allow developers and user devices to define the behavior of the application without writing code, enabling customization and configuration of the platform.

After configuring the channel generator and content prompt template, generative models 335 may be queried to generate contents with different formats. The generative models may include, but is not limited to, a diffusion model 335a, a generative adversarial networks (GAN) model 335b and/or a variational autoencoder (VAE) model 335c. The generative models may be adaptively selected based on the different formats indicated by the user devices. In some aspects, instead of using a single, fixed generative model, generation agent actions setup component 300 can dynamically choose the most appropriate generative model for a specific task or input, based on at least real-time conditions, user preferences, and/or metadata files 365 of the platform or user behaviors.

In some aspects, the diffusion model may refer to a type of generative AI model that generate new data by progressively adding noise to existing data and then learning to reverse that process, effectively removing the noise and producing new, realistic data samples. In some aspects, the diffusion model may start as a forward process with an image and add Gaussian noise to it in small steps. The diffusion model may repeat this until the image is completely noise. The diffusion model may then start a reverse process that trains a neural network to predict the noise at each step and remove it, gradually transforming the noise back into an image or reconstruct a new image.

In some aspects, the GAN model is a type of machine learning model that includes two neural networks, a generator and a discriminator, that are trained in an adversarial process (e.g., the generator tries to fool the discriminator into classifying its generated samples as real, and the discriminator tries to accurately distinguish between real and fake samples) to generate new data samples that resemble the training data. For example, the generator may takes random noise as input and generate synthetic data samples (e.g., images, text, etc.). The discriminator may receive both real data samples from the training dataset and synthetic samples (e.g., with different formats) from the generator, and learn to distinguish between real and fake samples. As the training progresses, both the generator and discriminator improve their performance, with the generator learning to produce increasingly realistic synthetic data and the discriminator becoming better at identifying fake samples.

In some aspects, VAE model is a type of generative model in machine learning that learns a compressed representation of data and can generate new, synthetic data points by sampling from a learned latent distribution. The VAE model combines elements of autoencoders and probabilistic modeling. In some aspects, the VAE model may encode an image into a latent space and then decode the latent space into a new image which may be of higher quality than the original image.

After content generation, approval workflows 370 may be triggered. The approval workflow may streamline or replace the manual approval flow that multiple functional groups or departments may be involved in the decision making about an external facing content. In some aspects, the automated approval workflow of generated content can be also triggered via a pre-configured approval chain in which the approval chain can be subject to certain rules that can be triggered to ensure that the approval of all required individuals or procedures are sought. For example, each approval workflow may outline specific steps, including who needs to review and approve, and in which order. Roles and responsibilities of each individuals or approver (e.g., this could be an AI agent, an automated approval entity, and/or any systems or models) can be defined, ensuring that the right entity are involved in the approval process. Approvers within the approval workflow may also be notified when a task or document is awaiting their approval. In addition, during the workflow approval, an audit trail approvals and rejections can be created and stored for any subsequent internal or external audit purposes.

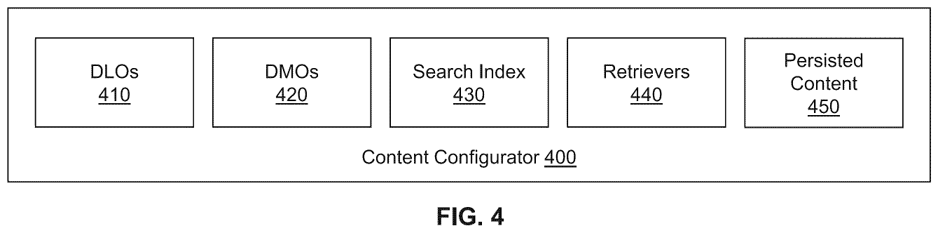

FIG. 4 is a block diagram illustrating a content configurator 400 of a content generation engine 120, according to aspects of the present disclosure. In some aspects, content configurator 400 may include, but is not limited to, data lake objects (DLOs) 410, data model objects (DMOs) 420, a search index 430, a retriever 440, and/or persisted (persistent) content 450.

DLOs 410 may refer to storage containers within data cloud that ingest, store, and manage data from various sources, serving as a persistent data storage solution for the content configurator. The DLOs may be automatically created from data ingested into data cloud, but can also be created manually. The DLOs may include both internal DLOs and external DLOs in which the internal DLOs may store data directly within the content configurator but the external DLOs may act as references that point to data stored in any external data sources.

DMOs 420 may refer to harmonized groupings of data created from various sources, acting as a standardized way to organize and manage data of the content configurator. The DMOs may also be a foundation of data cloud models to provide a structured way to store and access data information and further facilitate connections and analysis across different data streams.

Search index 430 may refer to a mechanism of content configurator that stores and organizes keywords or searchable phrases (e.g., names, phone numbers, descriptions, and other relevant data) from documents and records, enabling a faster a more relevant search results (e.g., based on either a keyword search, a vector search and/or a hybrid search). In some aspects, search index 430 may pre-index the keywords or searching phrases instead of scanning all data each time a search is performed. The search index may also be updated in a real-time manner when a document or record is modified or added, ensuring that search results are always up-to-date. In some aspects, the search index may also store information about the search behaviors of the user devices. These stored search behaviors may allow for personalized search results based on individual user interactions. In some aspects, the search index may be used to ground AI responses to ensure accurate and relevant AI-generated content. In some aspects, the search index may store chunked and vectorized data (e.g., data preprocessed in a search-optimized way) that can be searched and retrieved from other applications. The search index may be created and managed in data cloud, for example, in a data space and may be associated with a DMO.

Retriever 440 may be refer to a tool that allows user devices to create custom and filtered searches to retrieve relevant data from a search index 430. The retriever may be configured to apply the search index to a specific use case and filter data based on criteria including category, recency, and/or location. In some aspects, the retriever may be a key component for RAG implementation in which the retriever may enhance the relevance and accuracy of the LLM responses by integrating structured and unstructured data into the prompts. In some aspects, the retriever may be customized within the content configurator for different search indexes.

Persisted content 450 may refer to data or content that is stored and can be accessed persistently. The persisted content may not be lost when user devices close their browser or session or when the application is restarted. In some aspects, the persisted content can be stored in space, including but not limited to, file storage location, document libraries, and/or as attachments to records. The persisted content can also be invoked in a flow to provide outcomes and to use the outcomes in the flow.

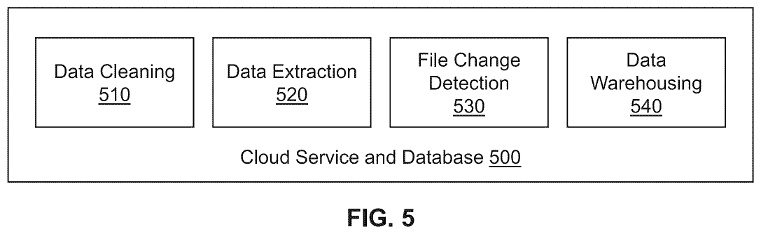

FIG. 5 is a block diagram illustrating a cloud service and database 500 of a content generation engine 120, according to aspects of the present disclosure. In some aspects, cloud service and database 500 may include, but is not limited to, data cleaning 510, data extraction 520, file change detection 530, and/or data warehousing 540.

Data cleaning 510 may refer to a process of identifying and correcting or removing inaccurate, incomplete, or irrelevant data within a dataset to improve its quality and usability for analysis or decision-making. In some aspects, data cleaning may involve identifying and addressing various data issues, including but not limited to, incorrect or inaccurate data (e.g., data with typos, errors in values, or inconsistencies in data formats), incomplete data (e.g., data with missing values or rows with missing data), duplicate data, irrelevant data, and/or data format inconsistencies.

Data extraction 520 may refer to a process of retrieving specific data from the platform for various purposes, including but not limited to, backups, reporting, and/or integrations. For example, in data backups, copies of data may be created for disaster recovery or historical analysis. Data reporting may include extracting data to create custom reports, dashboards, or perform data analysis. During the data extraction, data may also be migrated to other instances, systems, or applications for migration and integration purposes.

File change detection 530 may refer to a process of publishing events for changes to records (e.g., create, update, delete, undelete) of cloud service and database 500. The file change detection may enable a real-time synchronization of the cloud service and database with external systems that allows the user devices to track and react to the changes having been made. In some aspects, the file change detection may publish platform events that represent changes to the records in which the events may include information about the object, the record identifier, the fields having been changed, and/or the type of the changes. In some aspects, such events or changes may also be subscribed to by different external systems.

Data warehousing 540 may refer to a process of leveraging a centralized repository to store and manage large amounts of data from various sources for any analysis and reporting purposes. Unlike transactional databases that focus on real-time operations and transactions, the data warehousing facilitates reporting and data analysis using a consolidated view of historical data (e.g., it may also include current data). In some aspects, data warehouses may store data from multiple sources, including but not limited to, relational databases, transactional systems, and/or other internal or external sources. The data from these sources may be extracted and transformed into a suitable or optimized format before it can be loaded into the data warehouse.

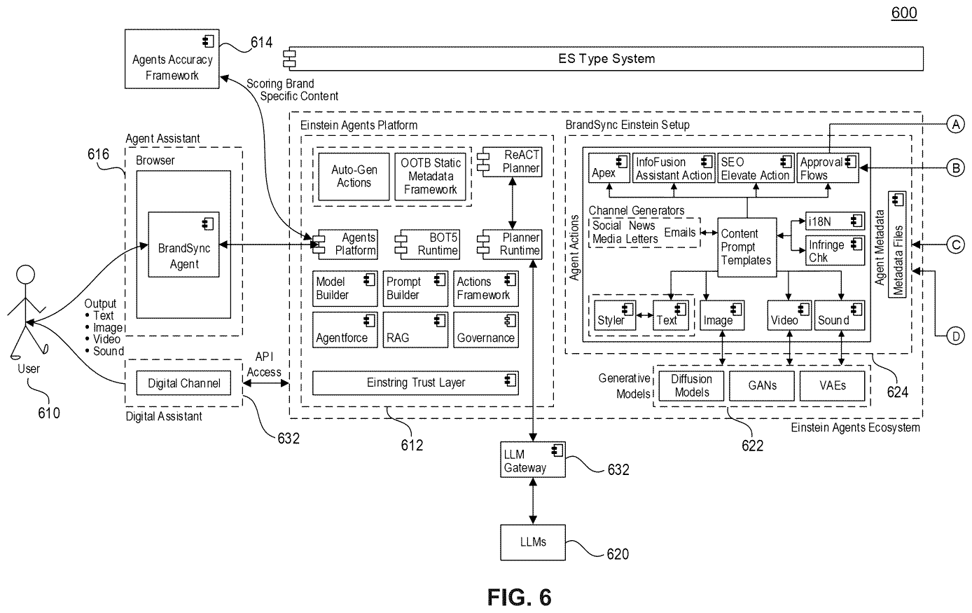

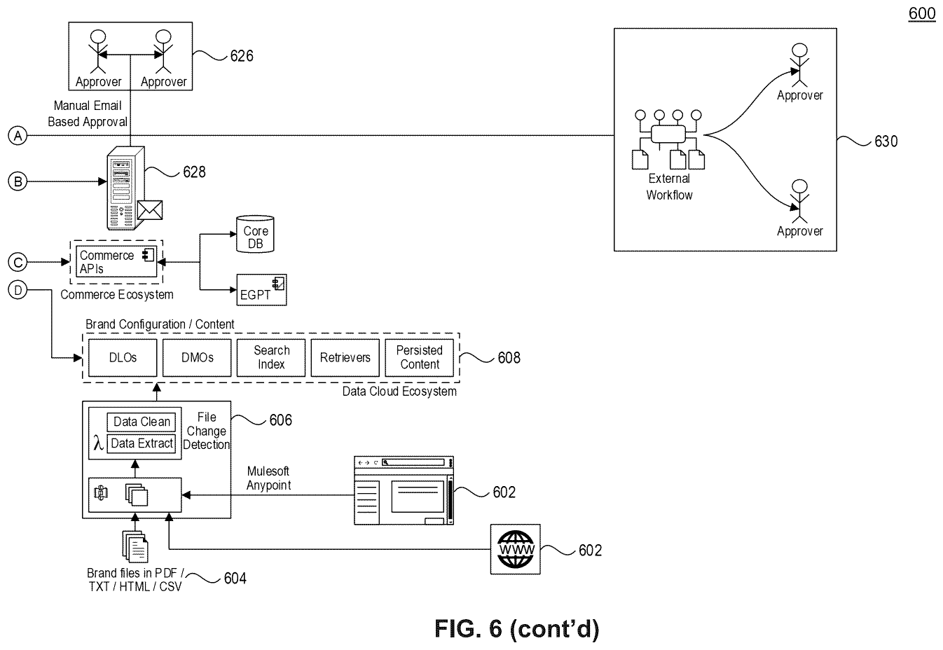

FIG. 6 is a block diagram illustrating an operational framework 600 of a content generation system 100, according to aspects of the present disclosure. FIG. 6 shall be described as an embodiment of FIG. 1. However, operational framework 600 is not limited to that embodiment. In some aspects, operational framework 600 may include multiple phrases, including but not limited to, configuration setup, user requirement capture, content generation, brand tuning, content approval, infringement checks, and/or output channel transformation. Using the enterprise's templates, content generation system 100 may format the generated content for output channels including newsletters, emails, social media posts, and/or marketing campaigns.

Configuration setup may refer to a process of defining the initial arrangements and settings of content generation system 100 in which the configuration setup may involve specifying any parameters to configuration to enable the system to function correctly and efficiently. The configuration setup process may also ensure that the system is properly initialized and ready for use. For example, during the configuration setup, the content generation system may customize the content generation for that enterprise to match the enterprise specific artifacts. Specifically, the configuration may include, but is not limited to, branding guidelines of the enterprise, styling artifacts to style content, and/or templates specific to the enterprise for content text generation.

In some aspects, the branding guidelines may support inputs from various formats, including trusted data format (TDF), hypertext markup language (HTML), text file format (TXT), and/or any other formats that would be appreciated my a person with an ordinary skill in the art. The styling artifacts to style content may be in any forms, including but not limited to, cascading style sheets (CSS), sassy cascading style sheets (SCSS), styling guide documents, and/or any other forms that would be appreciated my a person with an ordinary skill in the art. The template specific to the enterprise for content text generation may include, but is not limited to, popular template libraries, word processing document templates, and/or any other data libraries templates that would be appreciated my a person with an ordinary skill in the art. In some aspects, the branding guidelines, styling artifacts, templates, and other configurations may be provided by various sources, including but not limited to, external websites 602 and/or direct files 604. These configurations may then be connected and uploaded into a data cloud 606 via at least a direct file uploading, a cloud data cloud connector, and/or a data cloud library. Data ingestion may bring data into the data cloud in its original form and store it in a DLO.

In some aspects, after uploading the configurations (e.g., from multiple sources) into the data cloud, the configurations can then be organized in a database 608 (e.g., a data cloud system). Data streams and models may then be created to organize the data and queries and reports may be additionally built to access and analyze the data. Data models may define the structure of data within the data cloud and how it may map to the various objects and fields as a DMO in which the data from data streams may be mapped to the appropriate DMO structure. Once the data is organized within the database, content generation system 100 may use at least search index, retriever, and/or other tools of the database to search for the data in the database. These tools of the database may also support at least evaluating report data with formulas, summarizing data, and/or creating bucket columns for categorization of the data.

User requirement capture may refer to a phase in which a user 610 (e.g., a user device) expresses the desire for content generation for an output channel and in a specified format or combination of formats. For instance the user may specify “Generate content for a social media post for <subject with details> using text, images, videos, and audio.” After receiving the user prompt, an agent platform 612 may analyze the prompt and/or coordinate various agents based on the user prompt.

In some aspects, to address different types of user prompts or inquires, agent platform 612 may deploy various agents, including but not limited to, a service agent, a sales agent, a marking agent, a commerce agent, and/or a platform agent. The service agent may deflect incoming support cases by responding to customer inquiries. The sales agent may proactively contact customers, respond to their questions, and schedule meetings that may create any potential business. The marketing agent may generate briefs, audience segments, content, and customer journeys. The commerce agent may offer a shopping assistance on commerce sites or messaging apps. In some aspects, these agents deployed by the agent platform can also connect to database 608 and use it in real-time to plan, reason, and evaluate in which the agent platform may connect to at least enterprise data and security models to automate the operations.

In some aspects, agent platform 612 may be configured to interface with an agent accuracy framework 614 and an agent assistant 616. The agent evaluation framework may include a structured approach to assess and understand the performance of the deployed agents, focusing on their ability to execute tasks, make decisions, and interact with the user devices. In some aspects, the agent evaluation framework may also score the brand specific element or content stored in database 608 using text search capabilities or apply scoring algorithms based on the content's attributes. The scoring may be also based on relevance or other metrics to a user query. In some aspects, the agent assistant (e.g., a browser for the user devices) may be configured to open a remote takeover session on the endpoint or execute tasks on it, and it may allow the agent platform to connect to more than one device at the same time.

Content generation may refer to a process of creating digital media to be deployed on the internet or other channels. During the content generation, content generation system 100 can generate content for a user specified topic with any instructions. The generated content can also cover multiple output formats or modalities, including but not limited to, text, image, video and/or audio.

After receiving the user prompt and coordinating various agents to perform the task based on the user prompt, a content generation agent (e.g., part of agent platform 612) may be assigned to generate the content (e.g., text) based on the user specified topic in the prompt. For example, the content generation agent may query an LLM 620 via an LLM gateway 618 to create content of a suitable word count for any text generation tasks in which the word count may be a configurable parameter with defaulted to a certain value. The text generation prompt may be a combination of static instructions along with dynamic instructions created based on the user's utterance. In some aspects, the content generation agent may also utilize the LLM to perform tasks that require at least sequential reasoning, planning, and/or potentially, memory. These tasks may be designed to move beyond LLM responses by incorporating elements, including but not limited to, task decomposition, tool usage, and/or collaboration with other agents.

In some aspects, if images are needed along with the generated text, the content generation agent may use generative models 622 (e.g., diffusion, GAN models, or VAE models) to generate these images based on the user prompt. To use the generative models, the content generation agent may be configured to interface with an agent actions setup 624. After setting up the agent actions, the content generation agent may use the user utterance to generate instructions that would be supplied to the generative models. In some aspects, the input that the content generation agent may use is extracted from the branding guidelines of the enterprise, but if any clarifying questions need to be answered, those can also be asked back to user 610. The generated instruction (e.g., based on the user utterance) may then be issued to the generative models to generate the image. In some aspects, any changes suggested for the images having been generated may lead to alternation of the dynamically generated prompt instructions (e.g., by making alterations in the user's utterance) and further lead to generation of a new image. In addition, the content generation agent may identify the positions in which the images need to be embedded in the text. To determine the position of images, the content generation agent may evaluate each paragraph of the generated content to determine the best position for the generated images.

In some aspects, if sound is need along with the generated text and/or image, the content generation agent may also use generative models 622 to generate the sound based on the user prompt. The generated instruction (e.g., based on the user utterance) may then be issued to the generative models to generate the sound (e.g., audio) in terms of spoken commentary or background music. For example, the sound commentary may be generated with the right tonality and emotion for the different text snippets using the generative models. The background music may also be generated using the generative models but may be based on the overall mood of the generated text.

After obtaining text, image, and sound, in some aspects, if a video is needed, the content generation agent may stitch the obtained text, image, and sound into a video. In some aspects, to automatically align text, images, and audio during the stitching, any internal or external tools with synchronization features can be used. For example, the synchronization may align video clips (e.g., a sequence of images) to the beat of the audio. Audio waveforms may also be used for precision alignment with the video clips.

The generated content (e.g., text, image, video and/or audio) may then be rephrased or tuned according to the branding guidelines of the enterprise. To rephrase the generated content, the content generation agent may be configured to interface with database 608 storing and organizing these branding guidelines. Brand tuning of the content generation may refer to a process to refine the created content to align with a specific brand guidelines. During the brand tuning, the content generation agent can define how the content generation agent behaves, what resources (e.g., brand guidelines or any other contexts) it uses, and how it interacts with its environment, to ensure that generated content align with specific brand guidelines.

After the content is generated, the content may be subject to a content approval flow that has been defined in agent actions setup 624. This content approval flow may involve a collaboration between multiple functional groups or departments of the enterprise in the decision making about an external facing content. The content approval flow may support a manual mode and automated mode. All changes made during this content approval process may be maintained as a matter of audit.

In some aspects, in the manual mode, the content approval may be done via emails and managed by one or more approvers 626. A central person or device 628 may be responsible for consolidating any changes and making sure that the suggestions are incorporated. In the manual mode, the user may mark approval entries for generated content via a user utterance, such as “Mark the content <<content identifier>> with approval from <<name>> and email <<<Email>>.” In some aspects, in the automated mode, an automated approval flow 630 for generated content may be triggered via a pre-configured approval chain. This automated approval flow may also be subject to certain rules that are triggered to ensure that the approval of required approvers can be sought.

After the content is generated and approved, the content may further be subject to an infringement check that also has been defined in agent actions setup 624. The infringement check of the content may be based on one or more plagiarism detection algorithms or systems to prevent plagiarism in assignments and test. For example, a text matching may be applied by the plagiarism detection algorithms or systems between the content and a database of copyrighted content to detect any potential infringements. The plagiarism detection algorithms or systems may rely on fingerprinting hashes (e.g., a unique identifier) of document or content in which the fingerprint may allow the plagiarism detection algorithms or systems to search for it online and identify potential copies or unauthorized uses, even if the document or content has been edited or altered. The plagiarism detection algorithms or systems may also perform citation analysis in assessing the potential for infringement in a video or a document (e.g., a patent). For example, the citation analysis may involve examining how often a patent has been cited by other patents and publications, which can indicate the importance of the patent in its field and the potential for others to be infringing on it. A high number of forward citations suggests a patent is highly influential and likely to be used by others, potentially leading to infringement. In addition, NLP semantic match and cross-language plagiarism detection may also be used by the plagiarism detection algorithms or systems for the content-based infringement check to determine if two elements (e.g., a word, phrase, sentence, document, or even a corpus) have the same meaning.

After content is generated in the appropriate output format (e.g., text, image, video, and sound), the content may need to be set in a layout (e.g., an output template) that may be best suited for the output channels. For the enterprise and desired output channel, the appropriate template may be retrieved from the configuration. This template may be populated with the necessary text. For the image, video, and audio content, appropriate links may be inserted along with the necessary thumbnails output channel transformation. In some aspects, digital assistant 632 (e.g., digital channel) may use channels including live chat, SMS, email, and/or self-service portals to offer quick, convenient, and personalized interactions between agent platform 612 and user 610.

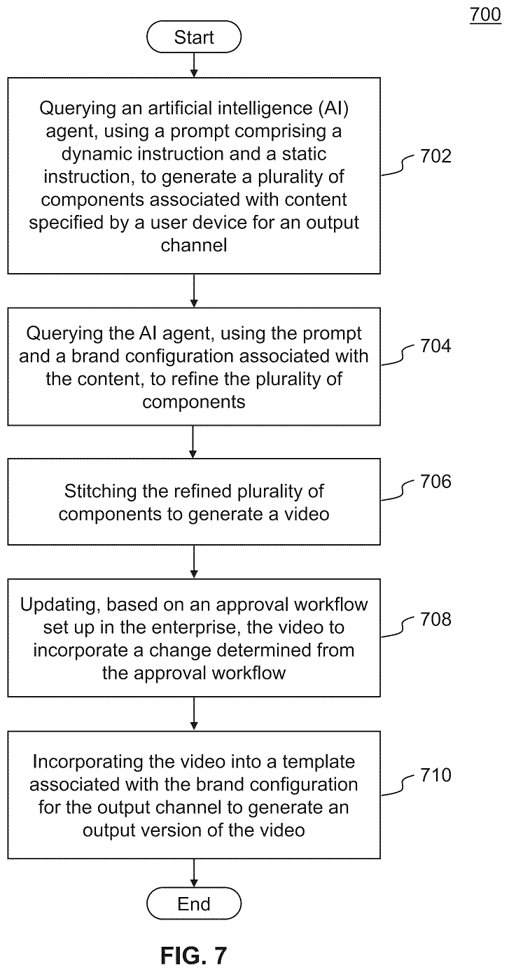

FIG. 7 is a flowchart illustrating a method 700 for brand adherent content generation, according to aspects of the present disclosure. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art. Method 700 shall be described with reference to FIG. 1-6. However, method 700 is not limited to those example aspects.

In 702, an AI agent may be queried by a content generation engine 120 using a prompt to generate a plurality of components associated with content specified by one or more user devices 110a-n for an output channel in which the prompt may include, but is not limited to, a dynamic instruction and a static instruction. The plurality of components associated with the content may include, but is not limited to, text, an image, and audio, in which the content may include a topic, an area of discussion, and relevant information or an explanation associated with the topic.

In some aspects, the text may include a plurality of text snippets in which a text snippet may further include a text commentary inserted in the video. The image may be embedded into a position associated with the text snippet in which the position may be determined by at least analyzing the text snippet. The audio may include a sound commentary for the text snippet and a background music of the video in which the sound commentary may be generated based on at least a tonality and an emotion associated with the text snippet, and the background music of the video may be generated based on at least a mood of the text.

In some aspects, the dynamic instruction may refer to real-time, context-specific instructions to adapt the AI agent (e.g., one or more LLMs) behavior and outputs during interaction with the user devices. The dynamic instruction may be transcribed from a user utterance (e.g., the first user utterance) in which a NLP models or systems may be used to understand the context of the user device input and adjust the instruction dynamically. The dynamic instruction (e.g., based on a textual transcription of a first user utterance) may also include, but is not limited to, a real-time instruction from the user device for adapting at least one of a response or a behavior of the AI agent based on the content. In some aspects, the static instruction may refer to a fixed, unchanging instruction or prompt provided to the AI agent, without dynamic or external data being injected during runtime. The static instruction may also include, but is not limited to, a fixed instruction for generating the content for the output channel using the plurality of components. For example, the static instruction may be “Summarize the following text:” followed by a fixed text passage. The dynamic instruction may be “Summarize the following text: {text_to_summarize}”, where “{text_to_summarize}” can be replaced with a different text passage each time during the runtime process.

In 704, the AI agent may be queried by a content generation engine 120 using the prompt and a brand configuration associated with the content to refine the plurality of components. The brand configuration may include, but is not limited to, a textual, a visual, and/or a verbal representation of an enterprise. In some aspects, the brand configuration can be incorporated into prompts to ensure outputs of the AI agent align with a brand voice, language style, guidelines, and desired persona of the enterprise. In some aspects, specific keywords or phrases that are synonymous with the brand's identity may also be incorporated into the prompts. For specific applications such as email templates, the desired personas of both the sender and recipient may be defined in the prompt to ensure that the language style is appropriate. In some aspects, for example, without incorporating brand configuration, the prompt can be: “Write a response to a customer inquiry about shipping delays.” However, with Brand Configuration (e.g., assuming a brand that emphasizes customer satisfaction and quick responses, the prompt can be: “Write a friendly and empathetic response to a customer inquiry about shipping delays, using phrases like ‘We understand your frustration’ and ‘We're doing everything we can,’ and assure them of our commitment to a quick resolution.” The incorporating of the brand configuration into the prompt may allow for consistent brand representation, reduced compliance risks, and potentially increased customer satisfaction.

In some aspects, the AI agent being queried by a content generation engine 120 to generate the text may use at least an LLM and the AI agent being queried to generate the image or the audio may use at least one of a diffusion model or a GAN model. In some aspects, the generative models (e.g., LLM, diffusion model, GAN model, etc.) may be adaptively selected based on the different content or output channels indicated by the user devices. In some aspects, instead of using a single, fixed generative model, content generation engine 120 can dynamically choose the most appropriate generative model for a specific task or input, based on at least user preferences, user behaviors, or real-time conditions of the generation engine.

In 706, the refined plurality of components may be stitched by a content generation engine 120 to generate a video. In some aspects, to automatically align text, images, and audio during the stitching, any internal or external tools with synchronization features can be used. For example, during the synchronization, the content generation engine may align video clips (e.g., a sequence of images) with the beat of the audio. Audio waveforms may also be used for precision alignment with the video clips.

In 708, the video may be updated by a content generation engine 120 based on an approval workflow set up in the enterprise to incorporate a change determined from the approval workflow. The change may be translated by the content generation engine into a second user utterance transcribed into the dynamic instruction that directs the AI agent to refine the plurality of components.

In some aspects, the approval workflow may include, but is not limited to, a pre-configured approval chain in which the pre-configured approval chain may further include a plurality of rules that ensure the approval workflow to be executed by one or more user devices in a pre-defined order. In some aspects, the approval workflow may standardize the review and approval process, ensuring that necessary steps are followed before a decision is made. For example, the approval workflow may outline specific steps, including who needs to review and approve, and in which order. Roles and responsibilities of each individuals or approver (e.g., this may include an AI agent, an automated approval entity, and/or any systems or models) can be defined, ensuring that the right entity are involved in the approval workflow. Approvers within the approval workflow may also be notified when a task or document is awaiting their approval. During the workflow approval, an audit trail approvals and rejections can be created and stored for any subsequent internal or external audit purposes.

In 710, the video may be incorporated by a content generation engine 120 into a template to generate an output version of the video in which the template may be associated with the brand configuration for the output channel. To incorporate content (e.g., video or other formats) into a template for output channels, the content generation engine may need to define the structure and format of the template (e.g., based on different output channels), then populate the relevant content into the template. This may often involve using a template engine or system that allows the content generation engine to create a reusable template pattern for an output channel, which can then be filled with the generated content.

In some aspects, the template may be structured by a content generation engine 120 based on layout, content types, and any necessary placeholders for the content (e.g., the video or other formats) in which this template structuring may involve defining sections for headlines, paragraphs, images, lists, or table. The content generation engine may also determine if the template needs to accommodate any dynamic content, including but not limited to, dates, user information, or content from external sources. In some aspects, content generation engine 120 may also bind data or features from the output channel to a specific placeholder within the template in which this binding may involve using variables, fields, or other mechanisms to dynamically populate the data or features from the output channel to the template.

In some aspects, a user feedback on the generated plurality of components may be received from one or more user devices 110a-n in which the user feedback may provide an update to at least one of the text the image, or the audio. The generated plurality of components may then be updated by a content generation engine 120 based on the user feedback. In some aspects, the updating may further include altering the image based on at least one of a second image associated with the text downloaded from a website, a third image generated by the AI agent, or a fourth image supplied by the user device. In some aspects, the general process to replace or update an image in a video may involve at least importing both the video and the new image, adding the image to the timeline of the video, adjusting its duration and position, and then exporting the edited video.

In addition, an infringement check of the video may be performed by a content generation engine 120 based on one or more plagiarism detection algorithms. The video may then be updated to incorporate another change based on a result of the infringement check in which the other change (to be incorporated into the video) may prevent the video from plagiarizing another video with a copyright protection. In some aspects, content generation engine 120 may use any internal or external tools or systems that would be appreciated by a person with ordinary skill in the art to analyze the video's visual and audio content against a database of copyrighted materials. These tools or systems may compare the video's unique features to known copyrighted works and flag potential matches for additional review.

For example, content generation engine 120 may apply a text matching between the video and a database of copyrighted videos. The content generation engine may rely on fingerprinting hashes (e.g., a unique identifier) of document or video snippets in which the fingerprint may allow the content generation engine to search for it online and identify potential copies or unauthorized uses, even if the video or document has been edited or altered. The content generation engine may also perform citation analysis in assessing the potential for infringement in a video or a document (e.g., a patent). For example, the citation analysis may involve examining how often a patent has been cited by other patents and publications, which can indicate the importance of the patent in its field and the potential for others to be infringing on it. A high number of forward citations suggests a patent is highly influential and likely to be used by others, potentially leading to infringement. In addition, NLP semantic match and cross-language plagiarism detection may also be used for the content-based infringement check to determine if two elements (e.g., a word, phrase, sentence, document, or even a corpus) have the same meaning.

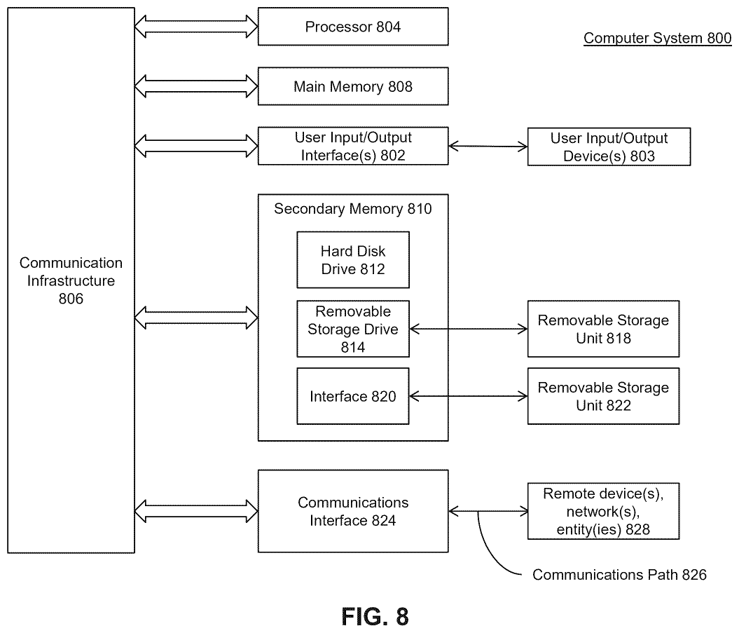

Various aspects may be implemented, for example, using one or more well-known computer systems, such as computer system 800 shown in FIG. 8. For example, aspects herein using the content generation system may be implemented using combinations or sub-combinations of computer system 800. Also or alternatively, one or more computer systems 800 may be used, for example, to implement any of the aspects discussed herein, as well as combinations and sub-combinations thereof. A “module,” as the term is used herein, is a computational element that performs one or more functions according to computer readable instructions stored on one or more memories or other non-transitory computer-readable media.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800 or processor(s) 804), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 8. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A method using one or more processors, comprising:
querying an artificial intelligence (AI) agent, using a prompt comprising a dynamic instruction and a static instruction, to generate a plurality of components associated with content specified by a user device for an output channel, the plurality of components comprising text, an image, and audio;
querying the AI agent, using the prompt and a brand configuration associated with the content, to refine the plurality of components, the brand configuration being incorporated into the prompt comprising a textual, a visual, or a verbal representation of an enterprise;
stitching the refined plurality of components to generate a video;
updating, based on an approval workflow set up in the enterprise, the video to incorporate a change determined from the approval workflow, wherein the change is translated into a user utterance transcribed into the dynamic instruction that directs the AI agent to refine the plurality of components; and
incorporating the video into a template associated with the brand configuration for the output channel to generate an output version of the video.

2. The method according to claim 1, wherein the dynamic instruction based on a textual transcription of another user utterance comprises a real-time instruction from the user device for adapting a response of the AI agent based on the content, and wherein the content comprises a topic, an area of discussion, and relevant information or an explanation associated with the topic.

3. The method according to claim 1, wherein the static instruction comprises a fixed instruction for generating the content for the output channel using the plurality of components.

4. The method according to claim 1, wherein:
the AI agent being queried to generate the text uses at least a large language model (LLM), and
the AI agent being queried to generate the image or the audio uses at least one of a diffusion model or a generative adversarial network (GAN) model.

5. The method according to claim 1, further comprising:
receiving a user feedback on the generated plurality of components, wherein the user feedback provides an update to at least one of the text, the image, or the audio; and
updating, based on the user feedback, the generated plurality of components.

6. The method according to claim 5, wherein the updating further comprises:
altering the image based on at least one of:
a second image associated with the text downloaded from a website;
a third image generated by the AI agent; or
a fourth image supplied by the user device.

7. The method according to claim 1, wherein:
the text comprises a plurality of text snippets, a text snippet comprising a text commentary inserted in the video,
the image is embedded into a position associated with the text snippet, the position being determined by at least analyzing the text snippet, and
the audio comprises a sound commentary for the text snippet and a background music of the video, wherein:
the sound commentary is generated based on a tonality and an emotion associated with the text snippet, and
the background music of the video is generated based on a mood of the text.

8. The method according to claim 1, wherein the approval workflow comprises a pre-configured approval chain, the pre-configured approval chain comprising a plurality of rules that ensure the approval workflow to be executed by one or more user devices in a pre-defined order.

9. The method according to claim 1, further comprising:
performing, based on one or more plagiarism detection algorithms, an infringement check of the video; and
updating, based on a result of the infringement check, the video to incorporate another change, wherein the other change prevents the video from plagiarizing another video with a copyright protection.

10. A system, comprising:
a memory configured to store operations; and
one or more processors configured to perform the operations, the operations comprising:
querying an artificial intelligence (AI) agent, using a prompt comprising a dynamic instruction and a static instruction, to generate a plurality of components associated with content specified by a user device for an output channel, the plurality of components comprising text, an image, and audio;
querying the AI agent, using the prompt and a brand configuration associated with the content, to refine the plurality of components, the brand configuration being incorporated into the prompt comprising a textual, a visual, or a verbal representation of an enterprise;
stitching the refined plurality of components to generate a video;
updating, based on an approval workflow set up in the enterprise, the video to incorporate a change determined from the approval workflow, wherein the change is translated into a second user utterance transcribed into the dynamic instruction that directs the AI agent to refine the plurality of components; and
incorporating the video into a template associated with the brand configuration for the output channel to generate an output version of the video.

11. The system according to claim 10, wherein the dynamic instruction based on a textual transcription of another user utterance comprises a real-time instruction from the user device for adapting a response of the AI agent based on the content, wherein the static instruction comprises a fixed instruction for generating the content for the output channel using the plurality of components, and wherein the content comprises a topic, an area of discussion, and relevant information or an explanation associated with the topic.

12. The system according to claim 10, the operations further comprising:
receiving a user feedback on the generated plurality of components, wherein the user feedback provides an update to at least one of the text, the image, or the audio; and
updating, based on the user feedback, the generated plurality of components.

13. The system according to claim 10, wherein:
the text comprises a plurality of text snippets, a text snippet comprising a text commentary inserted in the video,
the image is embedded into a position associated with the text snippet, the position being determined by at least analyzing the text snippet, and
the audio comprises a sound commentary for the text snippet and a background music of the video, wherein:
the sound commentary is generated based on a tonality and an emotion associated with the text snippet, and
the background music of the video is generated based on a mood of the text.

14. The system according to claim 10, wherein the approval workflow comprises a pre-configured approval chain, the pre-configured approval chain comprising a plurality of rules that ensure the approval workflow to be executed by one or more user devices in a pre-defined order.

15. The system according to claim 10, the operations comprising:
performing, based on one or more plagiarism detection algorithms, an infringement check of the video; and
updating, based on a result of the infringement check, the video to incorporate another change, wherein the other change prevents the video from plagiarizing another video with a copyright protection.

16. A non-transitory computer-readable storage device having instructions stored thereon, execution of which, by one or more processing processors, causes the one or more processors to perform operations comprising:
querying an artificial intelligence (AI) agent, using a prompt comprising a dynamic instruction and a static instruction, to generate a plurality of components associated with content specified by a user device for an output channel, the plurality of components comprising text, an image, and audio;
querying the AI agent, using the prompt and a brand configuration associated with the content, to refine the plurality of components, the brand configuration being incorporated into the prompt comprising a textual, a visual, or a verbal representation of an enterprise;
stitching the refined plurality of components to generate a video;
updating, based on an approval workflow set up in the enterprise, the video to incorporate a change determined from the approval workflow, wherein the change is translated into a second user utterance transcribed into the dynamic instruction that directs the AI agent to refine the plurality of components; and
incorporating the video into a template associated with the brand configuration for the output channel to generate an output version of the video.

17. The non-transitory computer-readable storage device according to claim 16, wherein the dynamic instruction based on a textual transcription of another user utterance comprises a real-time instruction from the user device for adapting a response of the AI agent based on the content, wherein the static instruction comprises a fixed instruction for generating the content for the output channel using the plurality of components, and wherein the content comprises a topic, an area of discussion, and relevant information or an explanation associated with the topic.

18. The non-transitory computer-readable storage device according to claim 16, wherein:
the text comprises a plurality of text snippets, a text snippet comprising a text commentary inserted in the video,
the image is embedded into a position associated with the text snippet, the position being determined by at least analyzing the text snippet, and
the audio comprises a sound commentary for the text snippet and a background music of the video, wherein:
the sound commentary is generated based on a tonality and an emotion associated with the text snippet, and
the background music of the video is generated based on a mood of the text.

19. The non-transitory computer-readable storage device according to claim 16, wherein the approval workflow comprises a pre-configured approval chain, the pre-configured approval chain comprising a plurality of rules that ensure the approval workflow to be executed by one or more user devices in a pre-defined order.

20. The non-transitory computer-readable storage device according to claim 16, the operations comprising:
performing, based on one or more plagiarism detection algorithms, an infringement check of the video; and
updating, based on a result of the infringement check, the video to incorporate another change, wherein the other change prevents the video from plagiarizing another video with a copyright protection.
